(19) United States
(12) Patent Application Publication
(10) Pub. No.: US 2004/0028263 A1
(43) Pub. Date: Feb. 12, 2004

(54) Digital zoom skin diagnostic apparatus

(75) Inventor: Yoshiaki Sakamoto, Tokyo (JP)

Correspondence Address: ROSSI & ASSOCIATES, P.O. BOX 826, ASHBURN, VA, 20146-0826, US

(73) Assignee: RIC Company, Ltd.

(21) Appl. No.: 10/615,564

(22) Filed: Jul. 8, 2003

(30) Foreign Application Priority Data
Jul. 9, 2002 (JP) 2002-199539

(51) Int. Cl. G06K 9/00

(52) U.S. Cl. 382/128

(57) ABSTRACT

There is provided a digital zoom diagnostic apparatus that comprises a 6-milloion pixel digital camera that captures only one high-resolution color image of the entire face of a person to be diagnosed, calculating means for cutting out image data of a plurality of processing regions from the one captured image data to calculate skin parameters. The size of the image data of each of the processing regions is determined in advance according to respective calculation method of the skin parameters, so that even complicated arithmetic operations can be completed within a short period of time. The image data of the processing regions are then enlarged by digital-zooming and displayed on a liquid crystal monitor screen, and a printer outputs the diagnosis result in such a format that the digital zoom images are arranged in contrast with the calculated parameters, so that the diagnosis result and the parameter can be understood intuitively.

### FIELD OF THE INVENTION

1. Field of the Invention

The present invention relates to a digital zoom skin diagnostic apparatus.

2. Background of the Invention

Conventionally, skin diagnostic apparatuses which determine parameters indicative of skin color, texture, wrinkles, dullness, spots, roughness, temperature, elasticity, sensitivity, melanin, skin age, pore condition, the amount of sebum, and so forth by photographing-a part of the face of a person to be diagnosed have been put into practical use. Japanese Laid-Open Patent Publication No. 3-118036 has disclosed a skin diagnostic apparatus that determines parameters indicative of wrinkles and texture by performing image processing on skin images. Japanese Laid-Open Patent Publication No. 5-245113, Japanese Laid-Open Patent Publication No. 7-12544, Japanese Laid-Open Patent Publication No. 7-19839, and so forth have also disclosed skin diagnostic apparatuses that determine a plurality of parameters by performing image processing on enlarged skin images.

The conventional skin diagnostic apparatuses capture images at respective predetermined diagnostic positions such as the cheek, forehead, tail of the eye, etc. of a person to be diagnosed, and thus, it is necessary to take pictures a number of times corresponding to the number of the diagnosis positions. Therefore, even in the case where an operator under contract operates a camera, he or she easily mistakes the operating procedure and makes machine operation mistakes. Also, in the case of a system in which a person to be diagnosed has to take a picture by herself, a long explanation must be given to her via the screen of a personal computer.

### SUMMARY OF THE INVENTION

It is therefore an object of the present invention to provide a digital zoom skin diagnostic apparatus that enables a person to be diagnosed to complete photographing only by performing a small number of operations with the aid of a short explanation, and is capable of calculating skin parameters accurately with few operation mistakes.

To attain the above object, the present invention provides a digital zoom skin diagnostic apparatus comprising: a multi-pixel digital camera that captures a high-resolution image of the entire face of a person to be diagnosed; and a calculating means for cutting out image data of processing regions from the captured image data on the entire face to calculate skin parameters; wherein the size of the image data of the respective processing regions is determined in advance accordance with a method of calculating desired parameters,

According to the present invention, the digital zoom skin diagnostic apparatus perform image processing on relatively small image data cut out from original high-resolution and high capacity image data obtained by photographing the entire face, to thereby determine required skin parameters. The diagnosis result is represented by sentences selected for single or a combination of skin parameters, graphs of the skin parameters, or the like, and is outputted on a monitor screen and as a printout for a person to be diagnosed. It is preferred that the diagnosis result is arranged next to digital-zoomed images of processing regions, and a compressed image of the entire face is also attached to the diagnosis result. The sentences or graphs representing the diagnosis result are arranged next to digital-zoomed images of processing regions whose corresponding parameters have been calculated, so that they can be understood in association with the images.

The above and other objects, features, and advantages of the invention will become more apparent from the following detailed description taken in conjunction with the accompanying drawings.

### BRIEF DESCRIPTION OF THE DRAWINGS

FIG. 1 is a side view showing a digital zoom skin diagnostic apparatus according to a first embodiment of the present invention;

FIG. 2 is a view useful in explaining an example of display on a monitor screen according to the first embodiment;

FIG. 3 is a flow chart showing a diagnosing process according to the first embodiment;

FIG. 4 is a view useful in explaining how skin parameters are calculated according to the first embodiment;

FIG. 5 is a view useful in explaining a digital zoom skin diagnostic apparatus according to a second embodiment of the present invention; and

FIG. 6 is a view useful in explaining an example of display on a monitor screen.

### DETAILED DESCRIPTION

The present invention will now be described in detail with reference to drawings showing there to preferred embodiments thereof.

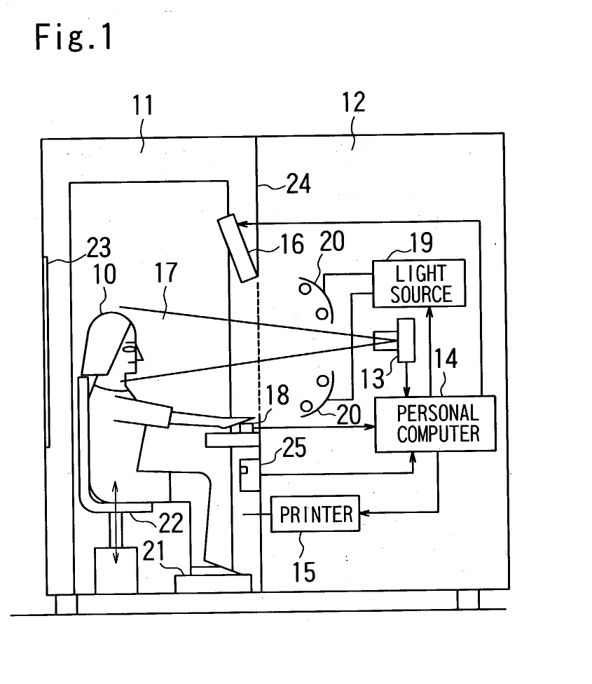

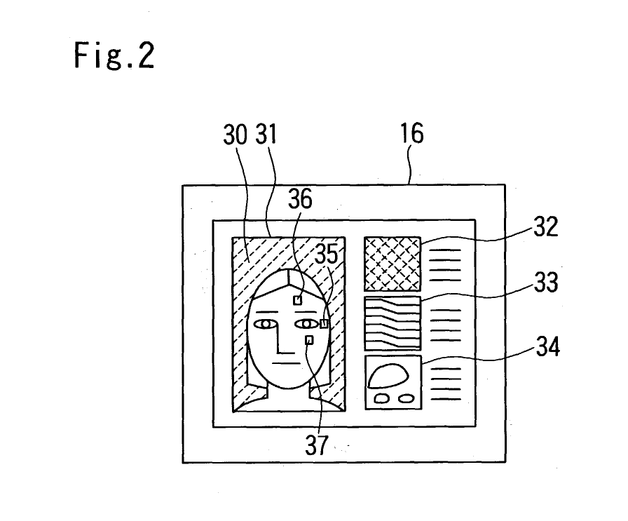

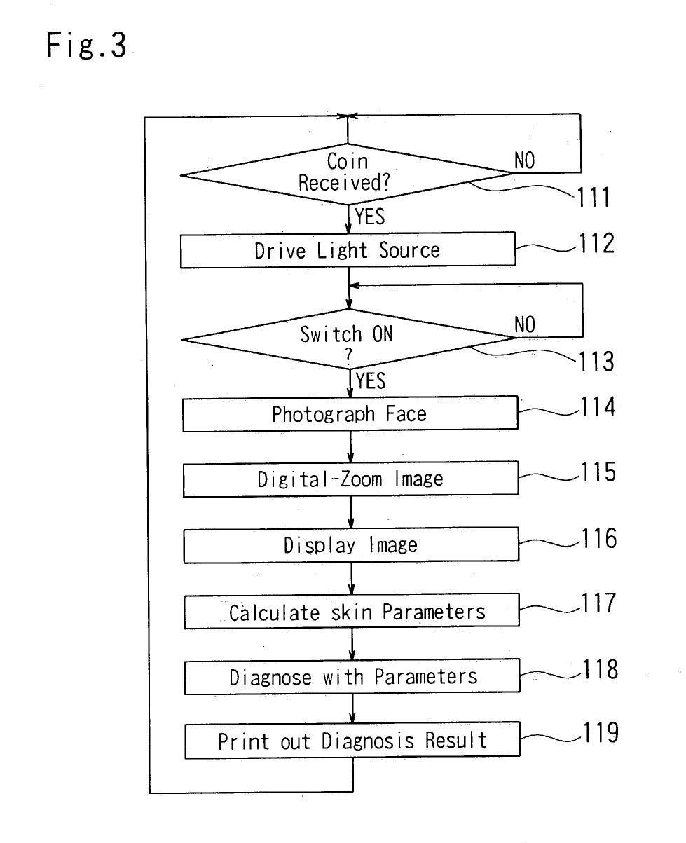

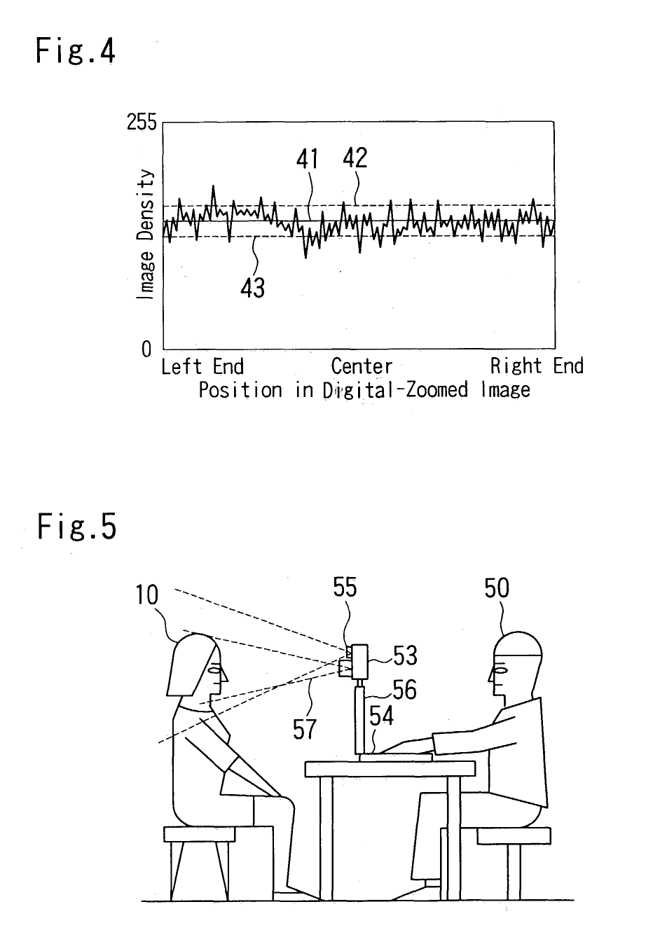

FIG. 1 is a side view showing a digital zoom skin diagnostic apparatus according to a first embodiment of the present invention, FIG. 2 is a view useful in explaining the display on a monitor screen, FIG. 3 is a flow chart showing a diagnosing process, and FIG. 4 is a view useful in explaining how skin parameters are calculated.

As shown in FIG. 1, the appearance and operation of digital zoom skin diagnostic apparatus according to the first embodiment are similar to those of an automatic certification photograph taking box or an automatic photo seal printing box. The digital zoom skin diagnostic apparatus according to the present embodiment is partitioned into a photographing room 11 and a machine room 12 by a shielding wall 24 with a transparent glass window formed at the center thereof.

A 6-million pixel digital camera 13 and a light source 19, which drives a high frequency-driven fluorescent lamp 20, are disposed in the machine room 12. A field angle 17 and focus of the digital camera 12 are controlled so as to capture the entire face of a person to be diagnosed 10 who is seated on a chair 22. A button 18, the light source 19, the digital camera 13, a coin slot 25 used for collecting fees, a liquid crystal monitor screen 16 arranged in the photographing room 11, and a printer 15 used for printing the diagnosis result are connected to a personal computer 14.

The chair 22 in the photographing room 11 is a high-backed chair that is capable of being adjusted in height and has a high backrest. The chair 22 positions the face of the person to be diagnosed 10 at a focal position in such a way as to face the digital camera 13 within the field angle 17 (photographing range). A narrow step 21 is intended to enable the person to be diagnosed 10 to be seated straight on the chair 22 by regulating the position of her feet to thereby prevent the face from getting out of the field angle 17. A blue background screen 23 is arranged on the wall at the back of the person to be diagnosed 10 so that the outline of her face can easily be distinguished automatically from an image obtained by photographing.

In response to the insertion of a 500-yen coin into the coin slot 25 by the person to be diagnosed 10 seated on the chair 22 in the photographing room 11, the light source 19 is operated to turn on the fluorescent lamp 20, and a live image is displayed on the liquid crystal monitor screen 16 so that the apparatus can be brought into photographing standby state. If the forehead is out of the field angle 17 on the live image, the person to be diagnosed 10 adjusts the height of the chair 22 and the like to position her face within the field angle 17. Subsequently, in response to the operation of the button 18 by the person to be diagnosed 10, the digital camera 13 is operated to capture an image of the entire face of the person to be diagnosed 10, and immediately transfers one image data of about 2000×3000 dots to the personal computer 14. The personal computer 14 displays the captured image on the liquid crystal monitor screen 16 and causes the printer 16 to output the diagnosis result at the same time.

On the liquid crystal monitor screen 16, enlarged images 32, 33, and 34 of three display regions cut out from the captured image data are displayed next to a compressed image 31 of the entire captured image as shown in FIG. 2. Further, frames 35, 36, and 37 corresponding to processing regions are displayed over the compressed image 31.

The processing regions correspond to image data, which are cut out in the optimum size for image processing and calculation of skin parameters. The processing regions are each 2 centimeters square in the exact size on the face, and are automatically set at three positions on the forehead, tail of the eye, and cheek by performing image processing on the entire captured image data to detect the outline and the eyes.

On the other hand, each of the display regions is set to be in a predetermined size such that the corresponding processing region is enlarged to the predetermined size at a predetermined digital-zooming magnification. The enlarged image 32 is obtained by digital-zooming image data of 1.5 centimeters square in the exact size, which is cut out from the processing region on the forehead (i.e. the frame 36), to 5 centimeters square and then dot-interpolating the digital-zoomed image data. The enlarged image 33 is obtained by digital-zooming image data of 3 centimeters square in the exact size, which is cut from the processing region at the tail of the eye covering a part of the eye (i.e. the frame 35), to 5 centimeters square. The enlarged image 34 at the bottom is obtained by digital-zooming image data of 3 centimeters square in the exact size around the processing region on the cheek (i.e. the frame 37), to 5 centimeters square. Shortly after the display of these images 32-34, the values of skin parameters and explanations thereof are displayed next to the enlarged images 32-34 corresponding to the processing regions on which operations have been performed. The enlarged image 32 corresponds to parameters indicative of skin color and pore condition, the enlarged image 33 corresponds to parameters indicative of texture and wrinkles, and the enlarged image 34 corresponds to parameters indicative of spots and dullness.

The personal computer 14 carries out a skin diagnosing process in a sequence shown in FIG. 3. In response to the receipt of a coin in step 111, the light source 19 is driven in a step 112 to bring the apparatus into photographing standby state. In response to the operation of the switch 18 in step. 113, the process proceeds to step 114 wherein photographing is performed and image data is transferred. Further, images are enlarged by digital-zooming in step 115, and the images are displayed on the liquid crystal monitor screen 16 in step 116. In step 117, the skin parameters are calculated by performing processing on the image data of three processing regions cut out from the captured image data. In step 118, the skin parameters calculated in three measuring regions are synthetically judged to obtain the diagnosis result, and printout data composed of the diagnosis result and the images is produced. In step 119, the printer 15 is operated to print out the diagnosis result for the person to be diagnosed 10.

As is the case with the display on the liquid crystal monitor screen 16 shown in FIG. 2, three images digital-zoomed at different magnifications are arranged in the same size next to a compressed image of the entire face, and the diagnosis result as to skin color, wrinkles, texture, spots, dullness, and pore condition, problems, cure, and recommended skin-care are described in detail on the printout of the diagnosis result.

As shown in FIG. 4, a horizontal density distribution function is found from the image data of the processing regions on the forehead and the cheek, and mean values 41 of the function are found for respective colors RGB to determine the skin color.

Further, the density of irregularities on the skin is found by counting the number of points intersecting two thresholds 42 and 43 set in the horizontal density distribution function. This operation is repeated for a plurality of horizontal cross lines set in the measuring regions on the forehead and the cheek, and the resulting values are averaged to calculate the parameter indicative of skin texture.

Further, the same operation is carried out for a plurality of cross lines set in image data of the processing region at the tail of the eye, and the resulting values are averaged to calculate the parameter indicative of wrinkles. Since the cycle of the irregularities of wrinkles is longer and the contrast thereof is higher than skin textures, the number of points crossing upper and lower thresholds set in a broader range as compared with those used for calculating the parameter indicative of skin texture is counted.

Further, an XY two-dimensional density distribution in the processing region on the forehead is found, and an operation is performed to binarize the image data with thresholds being varied to thereby extract pores. The parameter indicative of pore condition is calculated from the density and size of pores in the processing region.

Further, an XY two-dimensional density distribution is acquired from R image data in the processing region on the cheek, and an operation is performed to binarize the image data with thresholds being varied to thereby extract-spots (melanin). The parameter indicative of spots is calculated based on the size and number of spots. The parameter indicative of dullness is then calculated based on the parameters indicative of skin color, spots, and skin texture.

In the flow chart described above, the step 113 and 114 correspond to “control means” of the invention, and the step 117 corresponds to “calculating means”.

The digital zoom skin dynastic system constructed as described above photographs a region with a width of 20 cm and a height of 30 cm by a 6-million pixel digital camera and captures a high-resolution color image of about 2000×3000 dots, so that a sufficient amount of data of about 200×200 dots required for calculation of parameters can be ensured even from image data of a small processing region of 2 centimeters square. Further, if digital zooming from 1.5 centimeters square to 5 centimeters square is performed, it is possible to display and print out images with a sufficient resolution.

Further, since image data of a plurality of processing regions are cut out from one captured image data to calculate skin parameters, only one photographing action is required. Further, since the captured image data is stored in the personal computer 14, other measuring regions (e.g. the chin, the nose, and between the eyebrows) may be set later to calculate parameters.

Further, even if measuring regions cannot be automatically set in the captured image data when the outline of the face is out of the field angle 17, a person may manually set measuring regions again to recalculate parameters. If the calculated parameters were inconsistent with the actual condition, the reason why they are inconsistent can be analyzed by observing the entire captured image data. It is also possible to automatically exclude abnormal values by calculating parameters while shifting processing regions gradually. If the determination result were abnormal, there is no need for taking a picture again, and therefore, it is possible to quickly and surely collate the captured image data and a person although this is difficult in the case where partial images are captured.

Further, since each processing region is 2 centimeters square, it can be arranged on the face of a woman with a width of about 13 cm and a height of about 20 cm without getting out of the outline and without being affected by the irregularities on the face, the inclination of the face, the shade of illumination, and hairs. Since image data of each processing region is small data of 200×200 dots, heavy arithmetic operations required for complicated filter image processing can be completed within a short period of time.

Further, since the face of the person to be diagnosed 10 is set in predetermined position and direction by controlling her position and posture with the high-backed chair 22 and the narrow footstep 21, the outline of the face is less likely to get out of the field angle 17. Therefore, it is possible to acquire image data containing a large amount of information on the entire face captured to the limit of the field angle 17 of the digital camera 13.

Further, since the fluorescent lamp 20 is turned on upon the receipt of a coin to bring the apparatus into photographing standby state and the digital camera 13 is operated in response to the operation of the button 18 by the person to be diagnosed 10, even the fluorescent lamp 20 whose light quantity rises more slowly than a strobe is likely to achieve a steady illumination effect and the person 10 never closes her eyes at the same time as the photographing action.

Further, since image data of display regions is cut from the captured image data and supplied to the person to be diagnosed 10 via the liquid crystal monitor screen 16 and the printer 15, it is possible to provide persuasive information with reality. Since image data of a plurality of display regions are digital-zoomed at different magnifications and provided as images in the same size, it is possible to display and print out well-organized images with a pleasing appearance.

Further, since display regions and zooming magnifications are outputted in parallel with parameters calculated based on image data of processing regions corresponding to the display regions, the persuasiveness of the diagnosis result is increased so that even the person to be diagnosed 10 can intuitively understand the meaning of dry numerical values by referring to the numerical values in correspondence with images even if he or she is not skilled in the art. Since zoomed images of display regions are outputted in such a format as to be arranged next to an image showing the entire face, the person to be diagnosed 10 is less likely to object to the diagnosis result because of the reason and evidence presented with the result, and thus, there is a low possibility of receiving a claim from the person to be diagnosed 10 even if the apparatus outputs the diagnosis result unacceptable to her.

Further, since the sequence of operations from photographing to printing is carried out automatically under the control of the commercially available and inexpensive personal computer 14 to eliminate the need for operators or administrators under contract, it is possible to make more profits as compared with an automatic photographing box that takes certification photographs or prints out photo seals.

Incidentally, although in the above described first embodiment, the sequence of operations from photographing to printing is carried out automatically under the control of the personal computer 14, the present invention is not limited to this, but a special operator who provides counseling may attend the digital zoom skin diagnostic apparatus. For example, the liquid crystal monitor screen 16, switch 18, and keyboard are arranged on the external wall of the machine chamber 12, and an operator is seated in the machine chamber 12. The operator guides the person to be diagnosed 10 to take an appropriate posture from the outside of the photographing chamber 11 while a live image is displayed on the liquid crystal monitor screen 16, and the operator then starts photographing by operating the switch 18. The operator may ask the person to be diagnosed 10 some questions regarding diet, drinking, yesterday's sleeping hours, cosmetics he or she uses, and so forth and input answers through the keyboard.

Further, although in the above described first embodiment, the digital zoom skin diagnostic apparatus carries out skin diagnosis based on only image data captured by the digital camera 13, the present invention is not limited to this, but a measuring head comprised of an electrostatic capacity sensor may be provided to measure the amount of skin moisture as disclosed in Japanese Laid-open Patent Publication No. 59-28646 and parameters indicative of skin moisture may be added to diagnosis items. Further, a moisture evaporation measuring head may be additionally provided as disclosed in Japanese Laid-Open Patent Publication No. 10-286283, or a hypersteatosis measuring head may be additionally provided as disclosed in Japanese Laid-Open Patent Publication No. 56-158639.

Further, the digital zoom skin diagnostic apparatus according to the above described first embodiment may also be used as a business tool in cosmetics sales and as a communication tool in esthetic services.

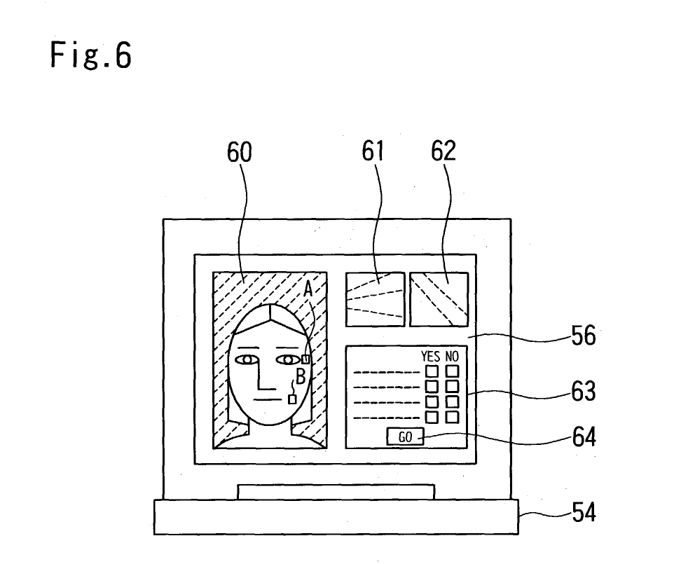

FIG. 5 is a view useful in explaining a digital zoom skin diagnostic apparatus according to a second embodiment of the present invention, and FIG. 6 is a view useful in explaining the display on a monitor screen. A description will now be given of a counseling system comprised of the minimum components; i.e. a notebook personal computer and a digital camera.

As shown in FIG. 5, a digital camera 53 is attached to the upper part of a monitor screen 56 of a notebook personal computer 54, and the notebook personal computer 54 and the digital camera 53 are connected to each other such that they may be remote-controlled and image data may be transferred.

The digital camera 53 operates a strobe 55 in response to an instruction from the notebook personal computer 54, and takes a high-resolution color image of the entire face of the person to be diagnosed 10.

A counselor 50 is opposed to the person to be diagnosed 10 and operates the notebook personal computer 54 to provide skin diagnosis and counseling for the person to be diagnosed 10. The counselor 50 guides the person to be diagnosed 10 to be seated in appropriate position and posture while looking at a live image shown on the monitor screen 56, and operates the notebook personal computer 54 to photograph the entire face of the person to be diagnosed 10. After photographing, an image is automatically transferred from the digital camera 53 to the notebook personal computer 54, and a measurement screen is then displayed as shown in FIG. 6. A compressed image 60 of the entire face of the person to be diagnosed 10 is displayed on the left-hand side of the monitor screen 56, and the counselor 50 sets square processing regions by dragging a mouse pointer on the compressed image 60. Image processing is automatically performed on a region A, which is set first, to calculate parameters indicative of wrinkles, texture, and skin color. Image processing is automatically performed on a region B, which is set second, to calculate parameters indicative of spots and melanin. Fixed frames for the regions A and B are displayed on the right-hand side of the monitor screen 56, and the manually set regions A and B are enlarged by digital-zooming at a variable magnification up to the limits of the two fixed frames to form enlarged images 61 and 62.

Further, a question frame 63 including with “YES” and “NO” boxes is displayed below the enlarged images 61 and 62. The counselor 50 reads out questions indicated in the question frame 63, and checks the “YES” or “NO” box in the question frame 63 according to answers from the person to be diagnosed 10.

By clicking a diagnosis switch provided in the lower part of the question frame 63 at last, the skin diagnosis result based on the calculated parameters and the questions and answers is displayed on the monitor screen 56. The skin diagnosis result includes the compressed image showing the entire face, on which the frames representing the processing regions are placed, and a plurality of digital-zoomed images corresponding to the diagnosis result. The counselor provides counseling by showing the person to be diagnosed 10 the monitor screen 56.

According to the second embodiment, the digital zoom skin diagnostic apparatus can be comprised of the minimum components; i.e. the notebook personal computer 54 and the digital camera 53, and therefore, it is possible to freely carry the digital zoom skin diagnostic apparatus and start diagnosis immediately at a place where the counselor visits. Further, since the system of the digital zoom skin diagnostic apparatus can be completed only by installing special software with commercially availably standard equipment, it is possible to promptly deliver inexpensive apparatuses with no inventory and to easily cope with troubles and change questions.

Further, since the counselor 50 provides skin diagnosis only by operating the notebook personal computer 54 and reading out questions in the question frame 63 displayed on the monitor screen 56, even a person who lacks expertise and experience may promptly acquire an accurate diagnosis result without wrong operation or determination.

Further, since a large mole, scar, or the like can be avoided in a flexible manner due to the manually set processing regions, an accurate diagnosis result can be acquired by selecting desired processing regions as is compared with the case where processing regions are set automatically and mechanically.

Incidentally, although in the above described second embodiment, the processing regions are set manually, the present invention is not limited to this, but processing regions may be set automatically by detecting the outline of the face and the eyes automatically.

According to the present invention, since skin parameters are calculated by cutting image data of a plurality of measuring regions from one captured image data, only one photographing action is required. Even the calculated parameters are wrong, there is no need for taking a photographing action once again. Further, since image data on which operations are to be performed is cut out to be reduced in data size, the diagnosis result can be outputted within a short period of time even if complicated calculation were needed by an inexpensive operation.

Further, the frequency of occurrence of photographing errors, operating errors, and calculating errors is lowered and the time can be saved as compared with the case where pictures are taken for a plurality of diagnosis positions by a hand-held camera head. Therefore, an accurate diagnosis result can be acquired promptly. Further, since an operator is not heavily burdened or is not required to have any special skills or qualifications, the diagnosis cost can be reduced.

Further, a person to be diagnosed can take a picture only by performing a small number of operations and with the aid of a short explanation, and skin parameters can be determined with few operation mistakes.

What is claimed is:

1. A digital zoom skin diagnostic apparatus comprising:
a multi-pixel digital camera (13) that captures a high-resolution digital image of an entire face; and
calculating means for cutting out image data of a processing region from the captured image data on the entire face to calculate skin parameters;
wherein a size of the image data of the processing region is determined in advance according to respective calculation method of said skin parameters.

2. A digital zoom skin diagnostic apparatus comprising:
a multi-pixel digital camera (13) that captures one high-resolution color image of an entire face; and
calculating means for cutting out image data of a plurality of processing regions from the one captured image data on the entire face to calculate skin parameters;
wherein a size of the image data of each of the processing regions is determined in advance according to respective calculation method of said skin parameters.

3. A digital zoom skin diagnostic apparatus comprising:
a digital camera (13) capable of outputting large-sized data;
control means for providing control such that said digital camera is operated to capture a high-resolution color image of an entire face of a person to be diagnosed;
calculating means for setting a processing region in the captured image data on the entire face, cutting out image data of the processing region, and performing processing on the image data of the respective processing regions to determine skin parameters; and
output means (15, 16) for outputting a skin parameter diagnosis result in which a digital zoom image of the processing region is arranged.

4. A digital zoom skin diagnostic apparatus comprising:
a digital camera (13) capable of outputting large-sized data;
control means for providing control such that said digital camera is operated to capture a high-resolution color image of an entire face-of a person to be diagnosed;
calculating means for setting a plurality of processing regions in the captured image data on the entire face, cutting out image data of the processing regions, and performing processing on the image data of the respective processing regions to determine skin parameters; and
output means (15, 16) for outputting a skin parameter diagnosis result in which digital zoom images of the plurality of processing regions are arranged.

5. A digital zoom skin diagnostic apparatus comprising:
regulating means (21, 22) for controlling a position and posture of a person to be diagnosed such that position and direction of a face of the person to be diagnosed are set to predetermined position and direction;
a digital camera (13) arranged so that an entire face of the person to be diagnosed is positioned within a field angle;
control means responsive to a triggering operation by the person to be diagnosed, for providing control such that said digital camera (13) is operated to capture a high-resolution color image of the entire face;
calculating means for cutting out partial image data of a small display region from the captured image data on the entire face; and
output means (15, 16) for outputting a digital zoom image of the display region for the person to be diagnosed.

6. A digital zoom skin diagnostic apparatus comprising:
a digital camera (13) that captures a high-resolution color image of an entire face of a person to be diagnosed; and
calculating means for capturing image data from said digital camera to calculate skin parameters;
wherein image data of a processing region designated by a pointer on the image of the entire face displayed on a monitor screen is enlarged by digital-zooming and outputted in such a format that the enlarged image is arranged next to the image data of the entire face.

7. A digital zoom skin diagnostic apparatus according to any one of claims 2 through 6, wherein:
a plurality of enlarged images, which are obtained by digital-zooming at different magnifications and are made uniform in size, are outputted in such a format that the plurality of enlarged images are arranged next to the image of the entire face.
